(19) United States
(12) Patent Application Publication
(10) Pub. No.: US 2026/0178540 A1
(43) Pub. Date: Jun. 25, 2026

(54) EFFICIENT SEARCHING OF STRUCTURED DATA USING MACHINE LEARNING MODELS

(71) Applicant: QUALCOMM Incorporated, San Diego, CA (US)

(72) Inventors: Guilherme HOEFEL, San Diego, CA (US); Diego CALZOLARI, San Diego, CA (US); Justin KAUFMAN, San Diego, CA (US)

(21) Appl. No.: 18/989,816

(22) Filed: Dec. 20, 2024

(51) Int. Cl. G06F 16/14

(52) U.S. Cl. CPC G06F 16/148; G06F 16/144

(57) ABSTRACT

Certain aspects of the present disclosure provide techniques and apparatus for efficient searching of structured data using machine learning models. An example method generally includes receiving a search request including an input data file as a search criterion. Using a first machine learning model, an embedding representation of the input data file is generated, and a compressed version of the input data file is generated based on the embedding representation of the input data file. One or more data files similar to the input data file are retrieved based on the compressed version of the input data file and compressed versions of data files in a data repository. The one or more data files are output as a response to the received search request.

### INTRODUCTION

Aspects of the present disclosure relate to neural networks, and more specifically, to efficient searching and data retrieval from data repositories using neural networks.

Data repositories generally store data that can be retrieved for future reference. For example, data repositories can store log data, genetic or chemical sequence data, or other data in a structured format (also referred to as structured data). Log data may generally record information recorded about activity performed in a system, such as a computing system. It would be beneficial to efficiently search and retrieve data from such data repositories.

### BRIEF SUMMARY

Certain aspects of the present disclosure provide a processor-implemented method for efficient searching of structured data using machine learning models. An example method generally includes receiving a search request including an input data file as a search criterion. Using a first machine learning model, an embedding representation of the input data file is generated, and a compressed version of the input data file is generated based on the embedding representation of the input data file. One or more data files similar to the input data file are retrieved based on the compressed version of the input data file and compressed versions of data files in a data repository. The one or more data files are output as a response to the received search request.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example pipeline for generating a compressed version of an input data file for searching for similar data files in a data repository, according to certain aspects of the present disclosure.

FIG. 2 illustrates an example of generating embeddings used by a machine learning model to generate a compressed version of an input data file, according to certain aspects of the present disclosure.

FIG. 3 illustrates an example pipeline for searching for data files in a data repository based on a compressed version of an input data file, according to certain aspects of the present disclosure.

FIG. 4 illustrates example operations for searching for data files in a data repository based on a compressed version of an input data file, according to certain aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for efficiently searching for structured data in a data repository using machine learning models.

Generally, searching for similar pieces of structured data to a given input sequence of structured data may be a time-consuming, computationally expensive task. For example, to identify historical log files showing a similar pattern of activity to a given input pattern of activity, a computing system can examine the contents of log files in a data repository individually to identify log files including a matching, or at least a potentially matching, pattern of activity. As the number of log files and the size of each log file grows, the amount of computing resources (e.g., processor cycles, memory bandwidth, etc.) used to search for similar patterns of activity may also grow, which may reduce the availability of computing resources for the execution of other tasks on a computing system.

Some machine learning models, such as encoders, classification models, or the like, allow for data to be converted into a point or other representation into a latent space. The distance between a latent space representation of different inputs into a machine learning model may indicate a level of similarity between these inputs. Generally, inputs with a small distance separating the respective latent space representations of these inputs may correspond to similar inputs, while larger distances separating these respective latent space representations of inputs may correspond to greater levels of dissimilarity between the inputs.

Aspects of the present disclosure provide techniques for efficiently searching structured data using machine learning models. Generally, the techniques discussed herein may leverage the ability of machine learning models to compress input data files (e.g., by encoding these input data files into a latent space) to allow for rapid comparisons of different data files based on a distance between compressed input data files and data files in a repository. Because a distance metric in a multidimensional space may be computed between different data files without directly comparing the content in different files, aspects of the present disclosure may allow for rapid comparisons between data files and rapid identification of data files that are similar to a given input file. Thus, aspects of the present disclosure may use fewer computing resources (e.g., processing cycles, memory, network bandwidth, power, etc.) to search for similar data files to an input data file.

For example, the structured data or input data files may include live traces of system calls, information about frequency bands to which a radio frequency device is tuned, or the like. This information may be used to find scenarios having a characteristic profile (e.g., identify ping-pong scenarios on a wireless communications device (i.e., a scenario in which an antenna is repeatedly and rapidly switched between two different antenna tuning configurations)), debug applications, troubleshoot systemic problems, perform security assessments on computing environments, and the like. For genetic or chemical sequence data, sequences of information may be used to identify similar molecules, similar deoxyribonucleic acid (DNA) sequences (e.g., for genetic testing), or the like. Certain examples will be described in detail below, and those of skill in the art will understand from the disclosure herein how similar data files to an input data file may be searched for and identified in a variety of different contexts and for any type of underlying data.

### Example Compression of Input Data Files Using Machine Learning Models

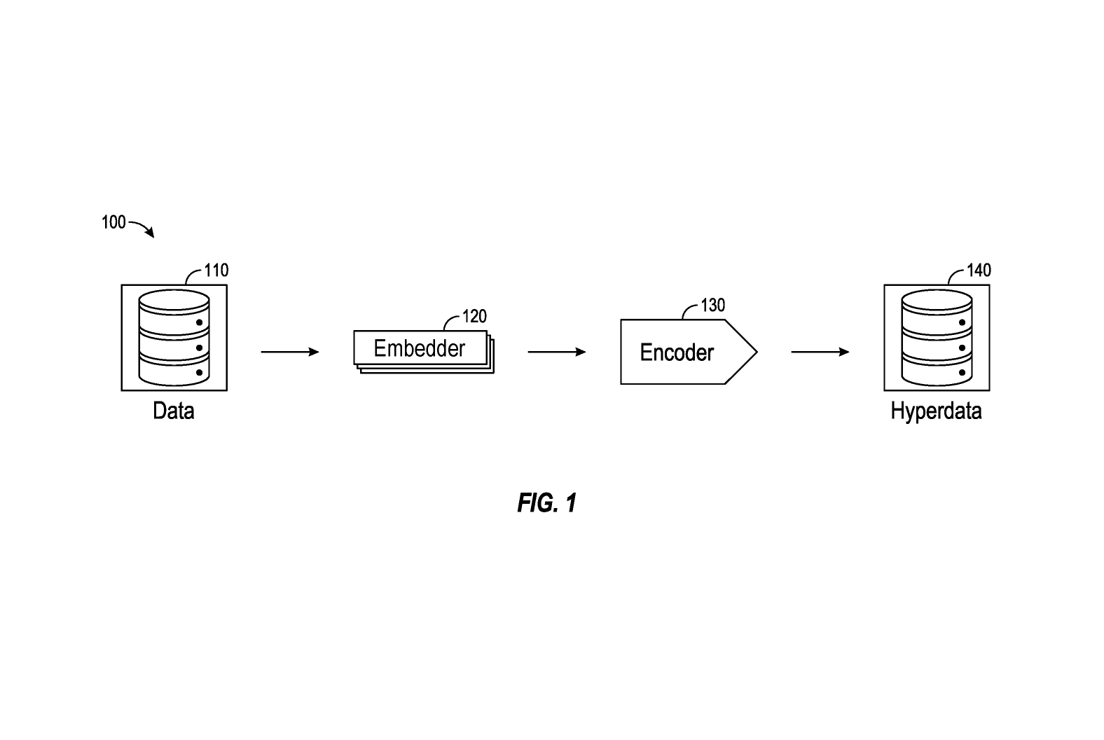

FIG. 1 illustrates an example pipeline 100 for generating a compressed version of an input data file for searching for similar data files in a data repository, according to certain aspects of the present disclosure. The pipeline 100 may be implemented by a single device, or the pipeline 100 may be distributed among multiple devices.

As illustrated, the pipeline 100 begins with retrieving a data file from a data repository 110. Generally, the data repository 110 may be or include one or more structured data files which are to be compressed using the pipeline 100 into a hyperdata repository 140. The hyperdata repository 140 may be part of the same or a different device than the data repository 110 (i.e., the hyperdata repository 140 may be a local data store or a remote data store). For example, the data repository 110 may be local to a device, whereas the hyperdata repository 140 may be located in a remote server. The one or more structured data files may include, for example, data logs recording activity in a computing system, data logs recording frequency tuning information for antennas on a wireless communications device, data logs recording calibration and/or testing information for a device during manufacturing or field testing, or the like. In some aspects, the one or more structured data files may include sequences of information, such as genetic sequences (e.g., sequences of nucleotides in DNA or ribonucleic acid (RNA), with different bases being represented by different symbols, protein sequences, chemical sequences, or the like). More generally, the structured data files include data files in which sequences of information may be information of interest which may be used as a search key or a target of a search.

As discussed, because the structured data files of the data repository 110 may be large and include an intractably large number of possible sequences, searching for files in the data repository 110 including a matching or near-matching sequence to a given input sequence may be computationally expensive, as a search may involve reading through the entirety of each structured data file in the data repository 110 in order to find data files including a sequence that matches or at least approximates the input sequence. However, because machine learning models allow for the generation of compressed representations of data that are easily comparable, the pipeline 100 generates compressed files stored in the hyperdata repository 140 via the embedder 120 and the encoder 130.

The embedder 120 generally represents a machine learning model that generates embedding representations of an input data file. For a structured data file in the data repository 110, the embedder 120 can generate one or more embeddings representing the data contained in the structured data file. The embeddings may be, for example, a vector or other data structure in a multidimensional space that compresses the structured data file or a portion thereof into a reduced dimensionality space. In some aspects, the embeddings may convert textual data to a numeric representation of the textual data in a structured data file so that other machine learning models can perform various operations with respect to these embeddings.

The embeddings generated by the embedder 120 for a structured data file may be input into an encoder 130 for compression. In some aspects, the encoder 130 may be a machine learning model trained to compress the embeddings generated by the embedder 120 to one or more data points in a multidimensional latent space. The resulting compressed version of an input data file may be stored in the hyperdata repository 140. Because the encoding or other compressed version of the structured data file generally includes points in a multidimensional space representing the structured data file or portions thereof, the hyperdata repository 140 may be a rapidly searchable repository that allows for the identification of similar data files in the data repository 110 based on comparisons between a compressed data file and compressed data files in the hyperdata repository 140. For example, a distance metric, such as a Euclidean distance, may be computed between an input data file and a compressed version of a file in the hyperdata repository 140 to determine whether the compressed version of the file in the hyperdata repository 140 includes similar data to the input data file. Generally, similar files may have smaller distances between compressed versions of those files, while less similar files may have larger distances between compressed versions of those files.

To facilitate searching of the data files in the data repository 110, each data file in the data repository 110 may be linked to a corresponding compressed file in the hyperdata repository 140. In some aspects, links between data files in the data repository 110 and compressed files in the hyperdata repository 140 may be established on a one-to-one basis such that each compressed file in the hyperdata repository 140 is associated with a unique source data file in the data repository 110.

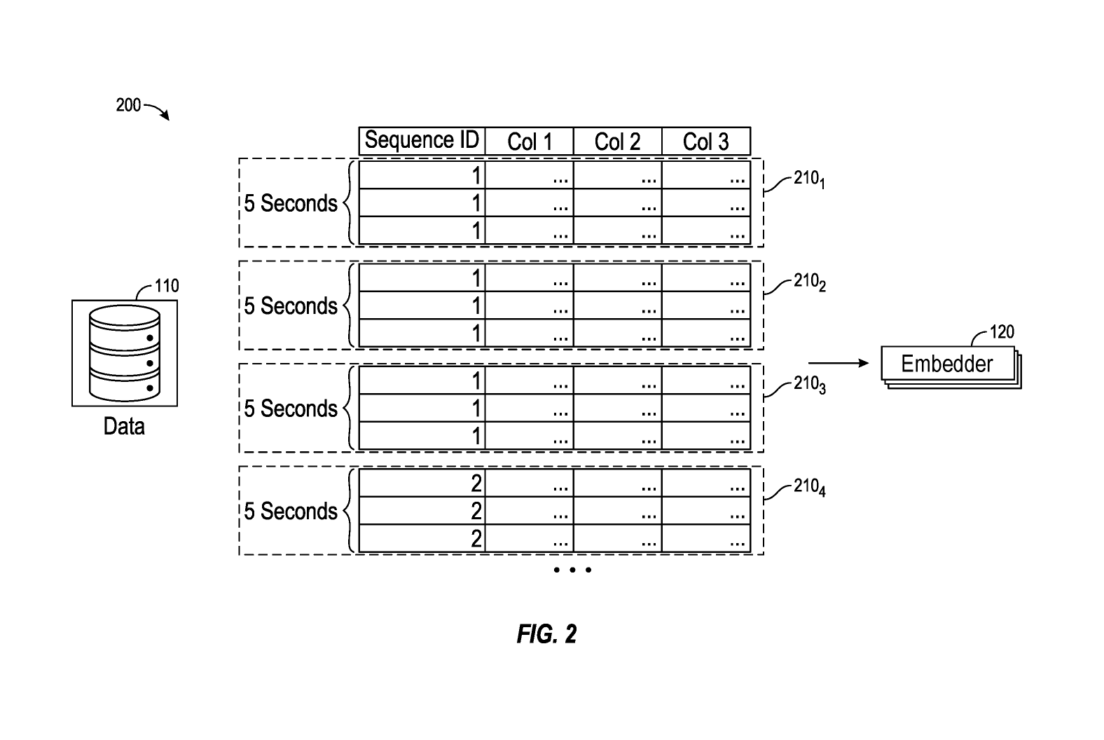

FIG. 2 illustrates an example 200 of generating embeddings used by a machine learning model to generate a compressed version of an input data file, according to certain aspects of the present disclosure.

As illustrated, to generate a compressed version of an input data file, the input data file may be retrieved from the data repository 110. Because an input data file, such as a log file, may include data of interest over discrete windows of time, the input data file may be divided into a plurality of segments 210₁, 210₂, 210₃, 210₄(and potentially others not illustrated in FIG. 2, and collectively referred to as “segments 210”). For example, as illustrated, the input data file retrieved from the data repository 110 may be divided into a plurality of segments including data logged over a five second time window; however, it should be recognized that an input data file may be divided into a plurality of segments over any appropriate length of a time window, and the five second time window illustrated in FIG. 2 is but an example of a time window over which an input data file can be segmented. In another example, a sequence of genetic data may be divided into segments 210 covering a defined number of nucleotides in the sequence. More generally, any structured data file which includes data that can be partitioned into a number of segments may be partitioned accordingly.

As illustrated, each segment 210 may include a plurality of entries in a structured format. For example, each segment 210 may represent a subset of a data table into which log data is organized, with each entry representing a row in the data table and with the data table including any number of columns. For a log file used to analyze antenna tuning parameters for a mobile phone or the like, the log file may include a timestamp column, a tuning frequency column, a tuner code or impedance value column, and/or the like. In another example, a log file may include information about access attempts into a computing system, such as a username, internet protocol (IP) address, geographic location from which access attempts were made, timestamps, and other information relevant to a sequence of events and analyses that can be performed therefrom (e.g., a determination of whether access attempts are malicious or legitimate, etc.).

Each segment 210 may be converted from the plurality of entries in the structured format defined for the input data file into an embedding representing the segment 210 by the embedder 120. The embedding may, for example, be a vector of numerical data that is generated to represent the data contained in the segment 210. In some aspects, as discussed, the embedder 120 may be a machine learning model trained to compress the data contained in a segment 210 into a more compact representation that is usable by an encoder or other compression machine learning model to generate a compressed version of an input data file (e.g., as a whole or on a per-segment basis).

Using the techniques illustrated herein, large structured data sets may be compressed significantly, reducing the computational expense involved in performing searches on such data sets. For example, a radio frequency front-end log file including log data for a large number of sessions may have an original size of 1.8 gigabytes. The embeddings generated by the embedder 120 may reduce the size of the log file to a repository that is substantially smaller than the log file (e.g., that is less than ten percent of the size of the log file), which may further be compressed by the encoder 130 to result in a table having a size that is even smaller (e.g., under three percent of the size of the log file). By drastically reducing the size of the universe over which searches are performed, certain aspects of the present disclosure may accelerate the completion of searches against structured data and allow for computing resources to be freed for use in executing other processes in a computing system.

### Example Efficient Searching of Structured Data Based on Compressed Versions of Data Files Generated by Machine Learning Models

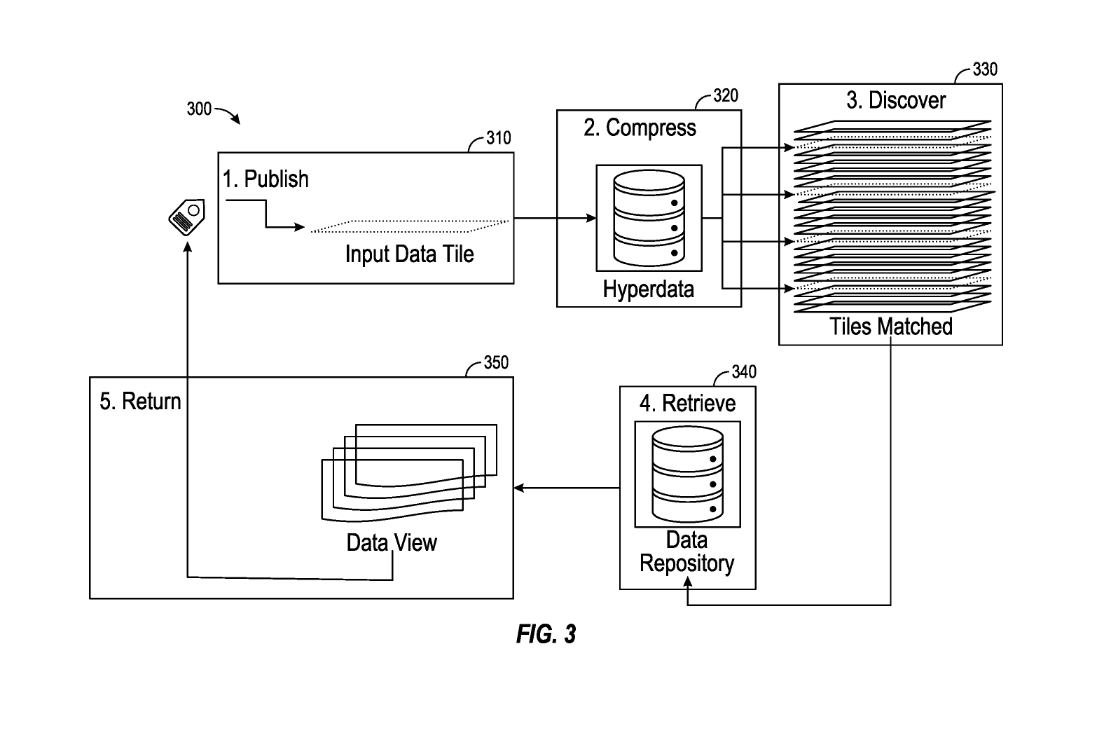

FIG. 3 illustrates an example pipeline 300 for searching for data files in a data repository based on a compressed version of an input data file, according to certain aspects of the present disclosure.

As illustrated, to search for similar data files to an input data file, the pipeline 300 may begin at block 310, with receiving an input data file (labeled an “input data tile” in FIG. 3) including a set of data serving as search criteria. Generally, the input data file may include information about a sequence of data for which similar results are to be returned. For example, in a radio frequency front-end log file scenario, the input data file may include log data corresponding to a ping-pong event experienced on a wireless communications device (e.g., an event in which the frequency to which an antenna is tuned repeatedly changes between values).

To allow for rapid identification of similar log files, the input data file published or received at block 310 may be compressed into a compressed version of the input data file at block 320. As discussed, the input data file may be compressed by generating one or more embeddings representing the log data or other structured data included in the input data file (e.g., by a machine learning model-based embedder, such as the embedder 120 illustrated in FIG. 1). These embeddings may be compressed using a compression machine learning model, such as the encoder 130 illustrated in FIG. 1. For example, a transformer may be used as the compression machine learning model.

At block 330, the pipeline 300 proceeds to identify matching files (e.g., data tiles) to the input data file (tile) received at block 310. As discussed, a hyperdata repository, such as the hyperdata repository 140 illustrated in FIG. 1, may include compressed versions of data files which can be compared to the compressed version of the input data file (tile) generated at block 320 to identify files including the same or similar content (or patterns of content). Because the compressed versions of the data files (tiles) in the hyperdata repository and the compressed version of the input data file (tile) generated at block 320 may be points or other encodings in a multidimensional space (e.g., a latent space into which an encoder encodes data and from which approximations of the data can be decoded by a corresponding decoder), similar files (tiles) to the input data file (tile) may be identified based on a distance measurement (e.g., a Euclidean distance) between the compressed version of the input data file (tile) and compressed versions of data files stored in the hyperdata repository. Generally, compressed data files in the hyperdata repository having a distance to the compressed version of the input data file below a threshold distance (also referred to as a relevant set of compressed data files) may be considered sufficiently similar to the input data file to be used in retrieving relevant data files to return to a user, while compressed data files in the hyperdata repository having a distance to the compressed version of the input data file exceeding the threshold distance may be insufficiently similar to the input data file and may not be used in retrieving relevant data files to return to the user. It will be understood that other representations or encodings of tiles may be used, and that other strategies for determining similarity may be implemented.

At block 340, the compressed data files in the relevant set of compressed data files may be used (e.g., as a key) to retrieve the corresponding data files from a data repository, such as the data repository 110 illustrated in FIG. 1. Generally, each data file in the data repository may be associated with a corresponding compressed version of the data file in the hyperdata repository on a one-to-one basis (e.g., a compressed version of a data file may not be associated with more than one data file in the data repository in which data files are stored). Based on this one-to-one association of compressed data files to uncompressed data files, data files associated with the compressed data files in the relevant set of compressed data files may be retrieved from the data repository, for example, by using the compressed data files as keys to identify the corresponding data file in the data repository.

At block 350, the retrieved data files are returned as search results to the search request received at block 310.

While FIG. 3 illustrates the retrieval of similar data files based on a search request including an input data file, it should be recognized that the pipeline illustrated in FIG. 3 may be used for a variety of tasks related to searching and automated description generation for data files in a data repository. For example, the compressed files in the hyperdata repository may be associated with a variety of labels describing attributes of each file. A search request received at block 310 may include a request for a description of an input data file specified in the search request. Based on the retrieval of similar data files from a data repository based on compressed data files in a relevant set of compressed data files, the labels associated with the compressed data files may be used to generate a response describing the input data file.

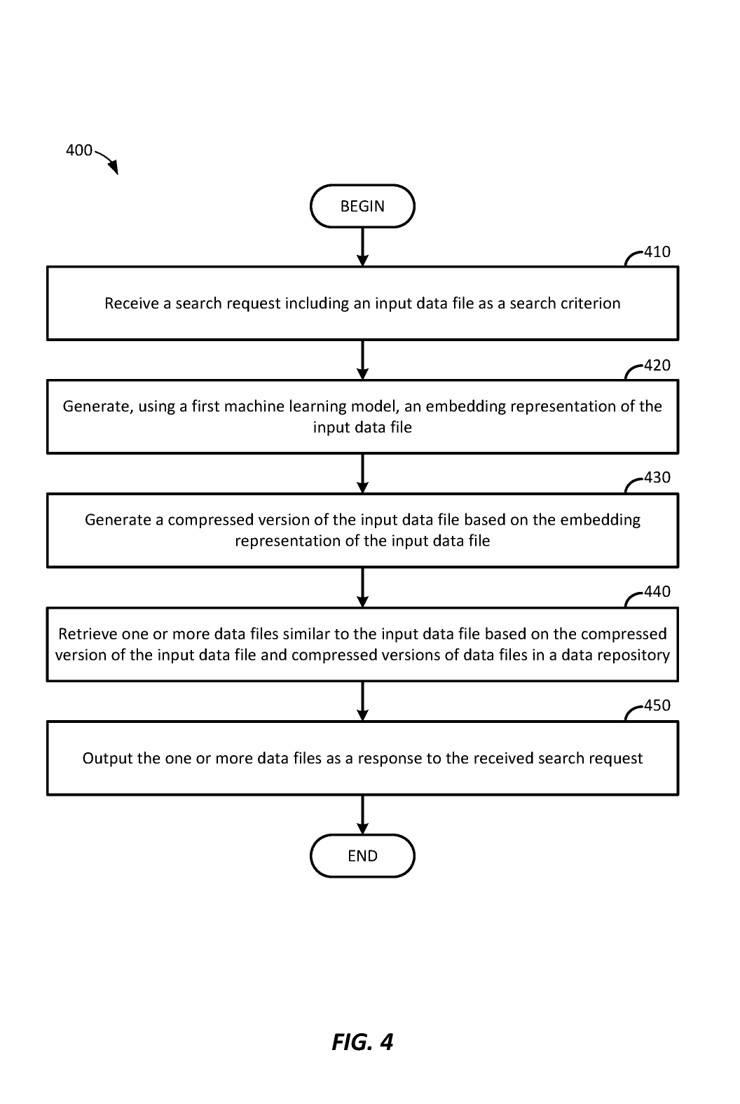

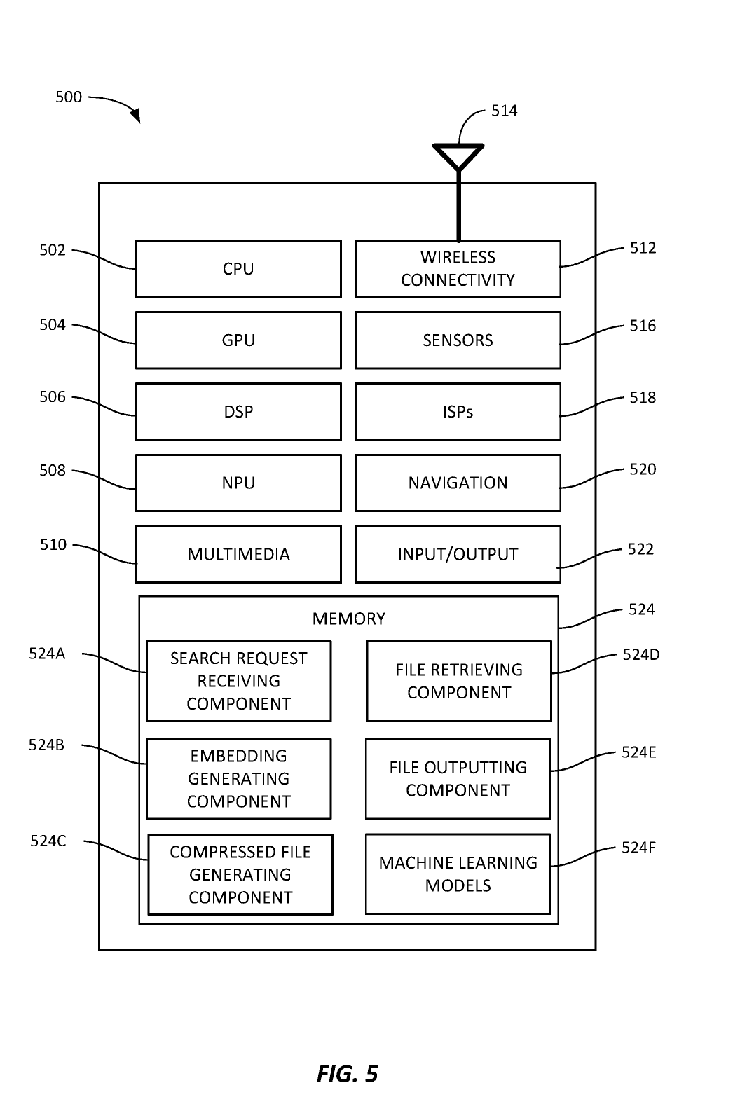

FIG. 4 illustrates example operations 400 for searching for data files in a data repository based on a compressed version of an input data file, according to certain aspects of the present disclosure. The operations 400 may be performed, for example, by a computing system on which one or more machine learning models can be used to compress structured data files and identify similarly structured data files based on the compressed versions of the structured data files, such as a server computer, a cluster of physical or cloud computing instances, a desktop computer, a laptop computer, or other computing systems (e.g., such as the processing system 500 illustrated in FIG. 5 and described in further detail below).

As illustrated, the operations 400 begin at block 410, with receiving a search request including an input data file as a search criterion.

At block 420, the operations 400 proceed with generating, using a first machine learning model, an embedding representation of the input data file.

At block 430, the operations 400 proceed with generating a compressed version of the input data file based on the embedding representation of the input data file.

In some aspects, generating the compressed version of the input data file comprises encoding the embedding representation of the input data file using a second machine learning model. The second machine learning model may be an encoder machine learning model trained to encode input data into a point in a latent space, such as a code in a code space from which a corresponding decoder machine learning model can reconstruct the input data. In some aspects, the encoder machine learning model may be an encoder portion of an autoencoder machine learning model, such as a variational autoencoder, or the like.

At block 440, the operations 400 proceed with retrieving one or more data files similar to the input data file based on the compressed version of the input data file and compressed versions of data files in a data repository.

In some aspects, retrieving the one or more data files similar to the input data file includes identifying, based on a similarity between the compressed version of the input data file and the compressed version of the data files in the data repository, a set of similar compressed versions of data files to the compressed version of the input data file. The one or more data files may be retrieved based on the set of similar compressed versions of data files to the compressed version of the input data file. In some aspects, identifying the set of similar compressed versions of data files to the compressed version of the input data file comprises identifying embedding representations within a threshold distance from the compressed version of the input data file. For example, as discussed above, each compressed version of a data file may be a latent space representation or code space representation of the corresponding data file. A distance metric, such as a Euclidean distance, can be used to identify a similarity between two different compressed data files (and thus, a similarity between the corresponding uncompressed data files). Generally, distances below a defined threshold distance may indicate that a file is sufficiently similar to the input data file for that file to be included in a set of results responsive to the search request, while distance above the defined threshold distance may indicate that the file is sufficiently dissimilar from the input data file such that the file is not to be included in the set of results responsive to the search request.

At block 450, the operations 400 proceed with outputting the one or more data files as a response to the received search request.

In some aspects, the input data file comprises a log file including a timestamp column and an activity description column. To generate the embedding representation of the input data file, the first machine learning model may generate a first embedding for the timestamp column and a second embedding for the activity description column.

In some aspects, the compressed version of the input data file comprises a plurality of embeddings, each embedding in the plurality of embeddings corresponding to a discrete block of time over which data in the input data file was captured.

In some aspects, the input data file comprises a nucleotide sequence.

In some aspects, the input data file comprises a radio frequency log. The input data file may be used to search for other situations in which similar radio behavior occurred, such as situations in which an operating frequency band oscillates between a first frequency band and a second frequency band within a defined period of time. In some examples, the input data file and/or the other situations may allow a user to identify a circumstance or setting that results in nonideal or inefficient operation. For example, it may be identified that the oscillation occurs when a device is in a certain location, attempting to connect to a certain network, attempting to communicate using a certain subset of carriers, etc.

In some aspects, the input data file comprises a calibration and testing log for a device (e.g. a wireless device) that is calibrated and tested after manufacturing before being shipped to a customer. The input data file may be used to search for similar scenarios in which a set of tests failed on other devices and help a test engineer or technician debug a problem with the device or the test(s) themselves.

In some aspects, the input data file comprises a vehicle data log (e.g., an autonomous vehicle data log). The input data file may be used to search for other situations in which similar vehicle behavior occurred, such as situations (i) in which a collision occurred at a certain impact angle range and/or speed range and a safety feature failed (e.g., an airbag failed to deploy) or (ii) in which an autonomous vehicle collided with an object after incorrectly departing from a paved surface.

In some aspects, the input data file comprises mixed data types (e.g., text, numerical data, date data, etc.). By generating an embedding representation of the input data file, the first machine learning model can generate numerical data representative of the input data file that can be used to generate a compressed version of the input data file for use in search and retrieval of relevant data files for the input data file.

In some aspects, the operations 400 further include generating a description of the input data file based on labels associated with compressed versions of data files in a data repository similar to the compressed version of the input data file.

In some aspects, the data repository is a local data repository. In other aspects, the data repository is a remote data repository. In this case, the retrieving at block 440 may involve (i) transmitting the compressed version of the input data file to the remote data repository and (ii) receiving the one or more data files similar to the input data file from the remote data repository

### Example Processing System for Efficient Searching of Structured Data Based on Compressed Versions of Data Files Generated by Machine Learning Models

FIG. 5 depicts an example processing system 500 configured to perform various aspects of the present disclosure, including, for example, the techniques described with respect to FIGS. 1 through 4. In some aspects, the processing system 500 may execute search operations based on comparisons between compressed versions of data files generated by machine learning models. Although depicted as a single system for conceptual clarity, in at least some aspects, as discussed above, the operations described below with respect to the processing system 500 may be distributed across any number of devices.

The processing system 500 includes a central processing unit (CPU) 502, which in some examples may be a multi-core CPU. Instructions executed at the CPU 502 may be loaded, for example, from a program memory associated with the CPU 502 or may be loaded from a partition of memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes a search request receiving component 524A, an embedding generating component 524B, a compressed file generating component 524C, a file retrieving component 524D, a file outputting component 524E, and machine learning models 524F. Though depicted as discrete components for conceptual clarity in FIG. 5, the illustrated components (and others not depicted) may be collectively or individually implemented in various aspects.

Generally, the processing system 500 and/or components thereof may be configured to perform the methods described herein.

In some examples, the processing system 500 may be one or more remote servers or other computer(s) capable of storing and processing files (e.g., log files) received from multiple devices (e.g., computers, smartphones, tablets, vehicles, wearable devices, Internet of Things (IoT) devices, and the like) and/or from different networks, in the manner described herein (e.g., the techniques described with respect to FIGS. 1 through 4). In such cases, the processing system 500 may be used, for example, to search for stored files of other devices having a similar pattern of activity to an input file. For example, an operator may identify a problem (e.g., with a certain pattern of activity) and operate the processing system 500 to search its files to determine if similar problems (e.g., with similar patterns of activity) have occurred in other devices, using the techniques described herein. In another example, a device may identify a problem and send an input file (or a compressed version thereof) to the processing system 500 (e.g., in the cloud), and the processing system 500 could identify similar situations or a correction based on similar situations (using the techniques described herein) and transmit this information back to the device.

In other examples, the processing system 500 may be or included in a device (e.g., a computer, smartphone, tablet, vehicle, wearable device, IoT device, and the like) capable of storing and processing files generated by the device itself, according to the techniques described herein. In these cases, the processing system 500 may be used, for example, to search for stored files of the device itself having a similar pattern of activity to an input file. For example, the device may identify a problem (e.g., with a certain pattern of activity) and then search its own files to determine if a similar problem had occurred before (perhaps with a correction for the device).

Notably, in other aspects, elements of the processing system 500 may be omitted, such as where the processing system 500 is a server computer or the like. For example, the multimedia processing unit 510, the wireless connectivity component 512, the sensor processing units 516, the ISPs 518, and/or the navigation component 520 may be omitted in other aspects. Further, elements of the processing system 500 may be distributed between multiple devices.

### EXAMPLE CLAUSES

Implementation details of various aspects of the present disclosure are described in the following numbered clauses:

Clause 1: A processor-implemented method for machine learning, comprising: receiving a search request including an input data file as a search criterion; generating, using a first machine learning model, an embedding representation of the input data file; generating a compressed version of the input data file based on the embedding representation of the input data file; retrieving one or more data files similar to the input data file based on the compressed version of the input data file and compressed versions of data files in a data repository; and outputting the one or more data files as a response to the received search request.

Clause 2: The method of Clause 1, wherein generating the compressed version of the input data file comprises encoding the embedding representation of the input data file using a second machine learning model.

Clause 3: The method of Clause 1 or 2, wherein: the input data file comprises a log file including a timestamp column and an activity description column; and generating the embedding representation of the input data file comprises generating, using the first machine learning model, a first embedding for the timestamp column and a second embedding for the activity description column.

Clause 4: The method of any of Clauses 1 through 3, wherein retrieving the one or more data files similar to the input data file comprises: identifying, based on a similarity between the compressed version of the input data file and the compressed version of the data files in the data repository, a set of similar compressed versions of data files to the compressed version of the input data file; and retrieving the one or more data files based on the set of similar compressed versions of data files to the compressed version of the input data file.

Clause 5: The method of Clause 4, wherein identifying the set of similar compressed versions of data files to the compressed version of the input data file comprises identifying embedding representations within a threshold distance from the compressed version of the input data file.

Clause 6: The method of any of Clauses 1 through 5, wherein the compressed version of the input data file comprises a plurality of embeddings, each embedding in the plurality of embeddings corresponding to a discrete block of time over which data in the input data file was captured.

Clause 7: The method of any of Clauses 1 through 6, wherein the input data file comprises mixed data types.

Clause 8: The method of any of Clauses 1 through 7, further comprising generating a description of the input data file based on labels associated with compressed versions of data files in a data repository similar to the compressed version of the input data file.

Clause 9: The method of any of Clauses 1 through 8, wherein the data repository is a remote data repository and wherein the retrieving comprises: transmitting the compressed version of the input data file to the remote data repository; and receiving the one or more data files similar to the input data file from the remote data repository.

Clause 10: The method of any of Clauses 1 through 9, wherein the input data file comprises a radio frequency log in which an operating frequency band oscillates between a first frequency band and a second frequency band within a defined period of time.

Clause 11: The method of any of Clauses 1 through 9, wherein the input data file comprises an autonomous vehicle data log.

Clause 12: The method of any of Clauses 1 through 9, wherein the input data file comprises a nucleotide sequence.

Clause 13: A processing system comprising: one or more memories comprising computer-executable instructions; and one or more processors coupled to the one or more memories and configured to execute the computer-executable instructions and cause the processing system to perform a method in accordance with any of Clauses 1 through 12.

Clause 14: A processing system comprising means for performing a method in accordance with any of Clauses 1 through 12.

Clause 15: A non-transitory computer-readable medium comprising computer-executable instructions that, when executed by one or more processors of a processing system, cause the processing system to perform a method in accordance with any of Clauses 1 through 12.

Clause 16: A computer program product embodied on a computer-readable storage medium comprising code for performing a method in accordance with any of Clauses 1 through 12.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for machine learning, comprising:
receiving a search request including an input data file as a search criterion;
generating, using a first machine learning model, an embedding representation of the input data file;
generating a compressed version of the input data file based on the embedding representation of the input data file;
retrieving one or more data files similar to the input data file based on the compressed version of the input data file and compressed versions of data files in a data repository; and
outputting the one or more data files as a response to the received search request.

2. The method of claim 1, wherein generating the compressed version of the input data file comprises encoding the embedding representation of the input data file using a second machine learning model.

3. The method of claim 1, wherein:
the input data file comprises a log file including a timestamp column and an activity description column; and
generating the embedding representation of the input data file comprises generating, using the first machine learning model, a first embedding for the timestamp column and a second embedding for the activity description column.

4. The method of claim 1, wherein retrieving the one or more data files similar to the input data file comprises:
identifying, based on a similarity between the compressed version of the input data file and the compressed version of the data files in the data repository, a set of similar compressed versions of data files to the compressed version of the input data file; and
retrieving the one or more data files based on the set of similar compressed versions of data files to the compressed version of the input data file.

5. The method of claim 4, wherein identifying the set of similar compressed versions of data files to the compressed version of the input data file comprises identifying embedding representations within a threshold distance from the compressed version of the input data file.

6. The method of claim 1, wherein the compressed version of the input data file comprises a plurality of embeddings, each embedding in the plurality of embeddings corresponding to a discrete block of time over which data in the input data file was captured.

7. The method of claim 1, wherein the data repository is a remote data repository and wherein the retrieving comprises:
transmitting the compressed version of the input data file to the remote data repository; and
receiving the one or more data files similar to the input data file from the remote data repository.

8. The method of claim 1, wherein the input data file comprises a radio frequency log in which an operating frequency band oscillates between a first frequency band and a second frequency band within a defined period of time.

9. The method of claim 1, wherein the input data file comprises mixed data types.

10. The method of claim 1, further comprising generating a description of the input data file based on labels associated with compressed versions of data files in a data repository similar to the compressed version of the input data file.

11. A processing system for machine learning, comprising:
at least one memory having executable instructions stored thereon; and
one or more processors configured to execute the executable instructions to cause the processing system to:
receive a search request including an input data file as a search criterion;
generate, using a first machine learning model, an embedding representation of the input data file;
generate a compressed version of the input data file based on the embedding representation of the input data file;
retrieve one or more data files similar to the input data file based on the compressed version of the input data file and compressed versions of data files in a data repository; and
output the one or more data files as a response to the received search request.

12. The processing system of claim 11, wherein to generate the compressed version of the input data file, the one or more processors are configured to cause the processing system to encode the embedding representation of the input data file using a second machine learning model.

13. The processing system of claim 11, wherein:
the input data file comprises a log file including a timestamp column and an activity description column; and
to generate the embedding representation of the input data file, the one or more processors are configured to cause the processing system to generate, using the first machine learning model, a first embedding for the timestamp column and a second embedding for the activity description column.

14. The processing system of claim 11, wherein to retrieve the one or more data files similar to the input data file, the one or more processors are configured to cause the processing system to:
identify, based on a similarity between the compressed version of the input data file and the compressed version of the data files in the data repository, a set of similar compressed versions of data files to the compressed version of the input data file; and
retrieve the one or more data files based on the set of similar compressed versions of data files to the compressed version of the input data file.

15. The processing system of claim 14, wherein to identify the set of similar compressed versions of data files to the compressed version of the input data file, the one or more processors are configured to cause the processing system to identify embedding representations within a threshold distance from the compressed version of the input data file.

16. The processing system of claim 11, wherein the compressed version of the input data file comprises a plurality of embeddings, each embedding in the plurality of embeddings corresponding to a discrete block of time over which data in the input data file was captured.

17. The processing system of claim 11, wherein the input data file comprises an autonomous vehicle data log.

18. The processing system of claim 11, wherein the input data file comprises a radio frequency log in which an operating frequency band oscillates between a first frequency band and a second frequency band within a defined period of time.

19. The processing system of claim 11, wherein the input data file comprises mixed data types.

20. The processing system of claim 11, wherein the one or more processors are further configured to cause the processing system to generate a description of the input data file based on labels associated with compressed versions of data files in a data repository similar to the compressed version of the input data file.
